(19) United States
(12) Patent Application Publication
(10) Pub. No.: US 2006/0119531 A1
(43) Pub. Date: Jun. 8, 2006

(54) Satellite support and method of use

(76) Inventors: James David Corpier, Clifton, TX (US); David Andrew Rhudy, Gatesville, TX (US)

Correspondence Address: ROBERT GREESON, 900 Washington Avenue, 7th Floor, P.O. Box 1470, Waco, TX, 77603-1470, US

(21) Appl. No.: 11/006,517

(22) Filed: Dec. 7, 2004

(51) Int. Cl. H01Q 3/02

(52) U.S. Cl. 343/882; 343/787

(57) ABSTRACT

An improved satellite structure device having a plate member, a connecting member and an elongate member. The plate member is extremely versatile in that it is configured to securely fit along any number of rooflines. Also, configuration of the support device provides for easy adaptation to different rooflines with no modification to the overall support device. The connecting member extends between the plate member and elongate member. Finally, the elongate member engages with any standard satellite and allows the satellite to be freely and fully adjusted. Use of the present invention eliminates the need for the typically relied upon “j-pole.”

### BACKGROUND OF THE INVENTION

1. Field of the Invention

The present invention generally relates to a satellite support apparatus. More specifically, the present invention relates to a satellite support apparatus that may be installed along virtually any roof in and eliminates the need of the generally used “j-pole.”

2. Background Information

The use of satellite support apparatus are known in the art. More specifically, satellite support apparatus's heretofore devised and utilized are known to consist basically of familiar, expected and obvious structural configurations, notwithstanding the myriad of designs by the crowded prior art which have been developed for the fulfillment of countless objectives and requirements.

Known documents include: U.S. Pat. No. 6,450,464, which relies on a tripod-like structure to support a satellite above the ground; and U.S. Pat. No. 6,734,830, which incorporates use of a frame combination to provide horizontal support for a satellite dish.

While these devices may fulfill their respective, particularly claimed objectives and requirements, the aforementioned documents do not disclose a satellite support apparatus such as Applicant's present invention.

In recent years the size and weight of residential-type satellite dish antennas has dramatically decreased. As a result, the installation and mounting procedures associated with these dishes has dramatically changed. For instance, satellite dish antennas are often installed and mounted in a variety of locations along the roof or side wall of a structure. Specifically, because these dishes are relatively small and lightweight, they are commonly installed and mounted along the soffit or fascia of the eve of a roof. In fact, these antennas can now be installed virtually anywhere along the eve of a roof, with a limiting factor being a clear path between the antenna and orbiting satellite.

Despite the improvements in installation procedure associated with smaller satellite dish antennas, there are pronounced limitations and inefficiencies associated with such installations. Typically, known devices have a mounting bracket to attach to a building and secure a satellite dish antenna extending from a “j-pole.” In view of the present invention, these devices are extremely limited. For instance, the mounting brackets used to interface between the building and satellite are often rectangular in shape. Such a product has several negative effects; that is, a rectangular mounting bracket does not securely fit against the fascia of a pitched roofline. This often leads to awkward installation as it is difficult to level the bracket or ensure the entire bracket rests against the fascia. Also, such an arrangement is generally aesthetically displeasing.

There are known mounting brackets shaped to conform to a pitched roofline. These products topically have a single slanted edge meant to but against the roof. However, even these products are limited in view of the present invention. Products having a single slanted edge can only match with a pitched roofline when facing a particular direction. Such a mounting bracket would have to be “flipped over” if placed along an oppositely pitched roofline. This inconvenience is greatly exaggerated in the common case where the mounting bracket is affixed to the satellite antenna.

Problems further arise in having to secure the mounting bracket and then also having to fix the satellite antenna and its support member to the bracket. Typically, a curved, elongate member (commonly referred to as a “j-pole” by those skilled in the art) extends between the mounting bracket and antenna dish. This j-pole must be adjusted and then fixed to the bracket; only then can the antenna dish be fitted atop the j-pole. Finally, the satellite is manipulated on the j-pole to find a sufficient signal and then secured on the j-pole.

Applicant's invention solves the problems of, and cuts-through the inefficiencies relate to, known satellite support mechanisms. The present invention incorporates a mounting bracket having two opposing slanted edges. As such, the mounting bracket may fit along a pitched roof rising from left-to-right, or from right-to-left, without being flipped over. Further, the present invention provides for a single, modular component having the necessary configuration to secure to a building and support a satellite antenna. This feature eliminates the need for use of a j-pole. Instead, the satellite may rest atop, and be adjusted upon, a single member serving as a mounting bracket and satellite support member.

While the distinctions associated with Applicant's invention may seem subtle at first glance, the startling results achieved with regard to installation efficiency by those skilled in the art strongly speak to its novelty and unobviousness. For the first time ever, one who installs satellites may rely on a single, pre-fabricated component to install a satellite antenna anywhere along the fascia of a pitched roofline. The net effect is a tremendous saving both with respect to installation time and efficiency, and the cost of component parts.

### SUMMARY OF THE INVENTION

The general purpose of the present invention, which will be described subsequently in greater detail, is to provide a new satellite support apparatus which has many of the advantages of such apparatus known in the art and many novel features that result in a new satellite support apparatus which is not anticipated, rendered obvious, suggested, or even implied by any of the known satellite supports, either alone or in any combination thereof.

In view of the foregoing, it is an object of the present invention to provide a satellite support apparatus that may be securely fitted along virtually any roofline.

It is another object of the present invention to provide a satellite support apparatus that maintains the benefits associated with, but eliminates the need for, a standard “j-pole.”

It is another object of the present invention to provide a satellite support apparatus that affords its user a tremendous savings with respect to installation time.

It is another object of the present invention to provide a satellite support apparatus that affords its user a tremendous savings with respect to ease of installation.

It is another object of the present invention to provide a satellite support apparatus that may be used on both a roof slanting upwards from right to left, or a roof slanting upwards from left to right, without any required modification.

It is another object of the present invention to provide a satellite support apparatus that allows great stability for any standard satellite dish while allowing that satellite dish to be freely adjusted.

In satisfaction of these and other related objectives, the present invention provides a satellite support apparatus. The present invention, by way of a novel combination of component parts, provides for an apparatus having a versatility and ease of installation not available with any known apparatus in the art. Applicant's invention is primarily characterized by a plate member, a connecting member, and an elongate member.

The plate member is primarily responsible for engaging with a house or other structure and providing overall stability to the present device. In its most preferred form, the plate member has a pair of slanted edges so that it may but against, and remain flush with, any number of standard rooflines. The connecting member may hold the plate member and elongate member fixed with respect to one another. However, particular forms are envisioned where each primary component rotatably or slideably moves with respect to the other. The elongate member receives a standard satellite dish along at its top end and is engaged with the connecting member at its bottom end. Importantly, the present device eliminates the need for use of a “j-pole.” Instead of using a standard “j-pole” combination, the present invention allows a satellite to be installed and remain supported along a roofline, all the while being fully adjustable along a single, vertical pole.

### BRIEF DESCRIPTION OF THE DRAWINGS

Applicant's invention may be further understood from a description of the accompanying drawings, wherein unless otherwise specified, like referenced numerals are intended to depict like components in the various views.

FIG. 1 is a front view of the apparatus of the present invention.

FIG. 2 is a side view of the apparatus of the present invention.

FIG. 3 is a rear view of the apparatus of the present invention.

### DETAILED DESCRIPTION OF THE PREFERRED EMBODIMENT

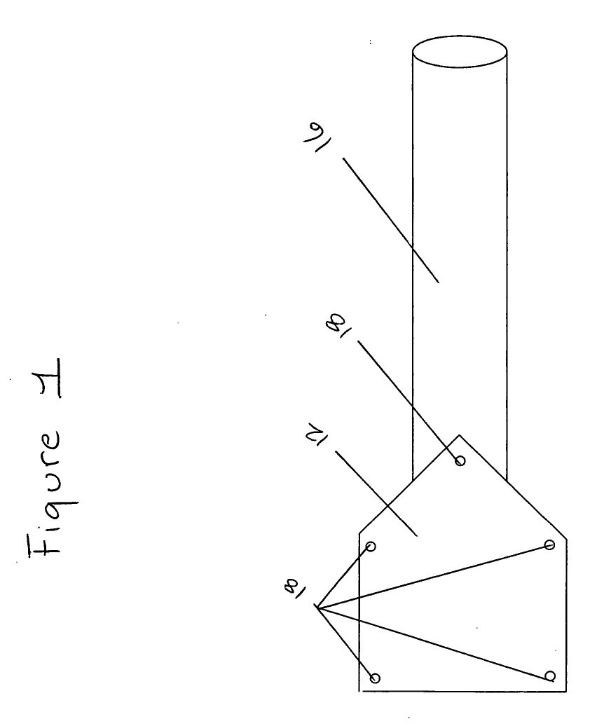

Referring to FIG. 1, the apparatus of the present invention is generally designated by the reference numeral 10. Device 10, in the preferred embodiment, is comprised of a suitably rigid material that is strong enough to support a satellite structure (and associated accessories), and yet is light enough to easily be manipulated and avoid undue strain on a building or some support structure. As such, device 10 is envisioned as being substantially comprised of some metal alloy, plastic composite, or fiberglass composite; although aluminum is the most preferred material comprising device 10.

Again referring to FIG. 1, device 10 is primarily characterized by plate member 12, intermediate member 14, and elongate member 16. In the preferred embodiment, each piece is forged to the other to form a single, modular piece. However, other useful embodiments are envisioned where plate member 12, support member 14, and elongate member 16 are reversibly engaged with one another by an attachment means (such as a series of clamps, screws, or pins). In these embodiments, intermediate member 14 may rotateably or slideably move with regard to plate member 12, and elongate member may rotateably or slidealbly move with respect to intermediate member 14.

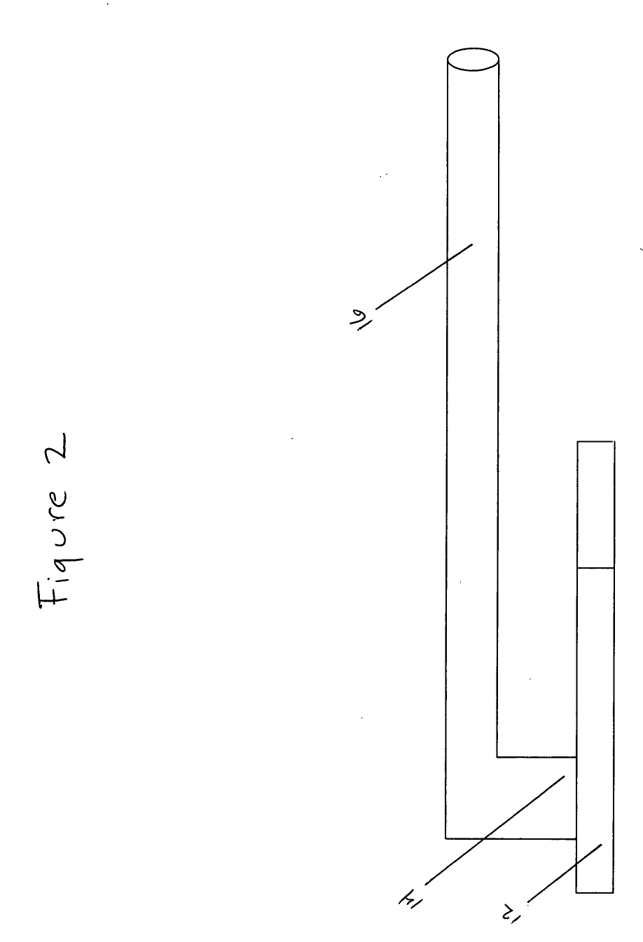

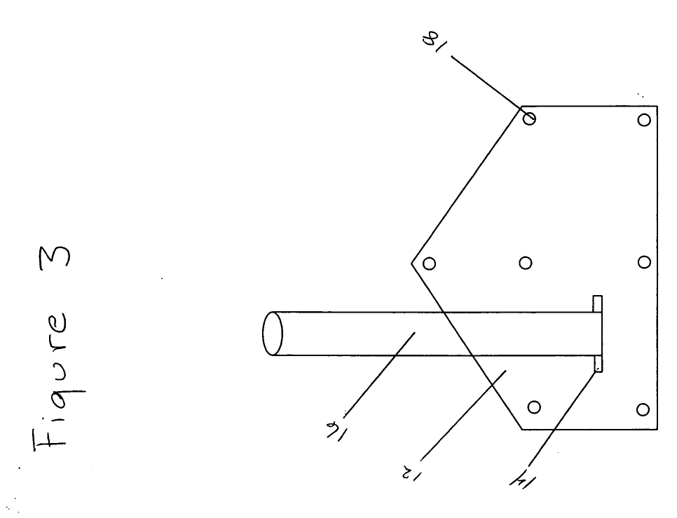

As best seen in FIG. 1, FIG. 2, and FIG. 3, plate member 12 is of a generally planar dimension. The specific dimensions of plate member 12 may be modified according to specific desired placement and function; for instance, useful embodiments are envisioned where plate member 12 is of a general rectilinear dimension having a single slanted edge to accommodate fitted and secure placement along the roofline of a house or other support structure. Also, various notches and grooves may be placed within plate member 12 so that device 10 can be “installed around” in-place structures. This allows device 10 to be placed within proximity of existing structures along the house or support structure. Finally, embodiments are envisioned where one or more curvilinear notches, grooves, or edges are incorporated to better accommodate secure installation in particularly difficult contexts (i.e., working around existing utilities, various accessories, or other satellite supports).

In the most preferred embodiment, plate member 12 is of generally rectilinear dimension with at least two slanted edges. These slanted edges join at some medial point. This configuration is preferred as it allows device 10 to be placed virtually anywhere along a roofline without modifying the relative configuration of elongate member 16. That is, device 10 may be placed along a portion of the roofline slanting upward from right to left, or slanting upward from left to right without being “flipped,” “rotated,” or adjusted in any manner. Obviously, the versatility imparted by such a configuration has far reaching effects. Device 10 can be securely fitted along any number of rooflines without the need for any adjust whatsoever with regard to the relative configuration of the remaining satellite support. This feature is simply not available with any known devices in the art.

Plate member 12 further contains a series of apertures 18. Each aperture 18 is sized and configured to allow some fastening means (such as screws, clamps, nails, etc) there through. During installation, plate member 12 receives some fastening means at apertures 18, or may be clamped, to be securely juxtaposed along the building surface. As such, apertures 18 are envisioned to have various diameters to better accommodate the specific type of fastening means to be inserted there through. Although the exact arrangement of apertures 18 is not crucial, each aperture is arranged within member 12 so as to provide adequate and distributed support as device 10 is mounted to a house or other structure. For instance, in the preferred embodiment, apertures 18 are evenly distributed about the peripheral of plate member 12 and further contain one or aperture about the center of member 12. Such a configuration of apertures 18 is thought to be particularly useful in providing distributed support for the weight of device 10 while preventing slipping, rotating, or some relative movement between the structure and plate member 12. Various adequate arrangements of the combination of apertures 18 will certainly be apparent to those skilled in the art.

Intermediate member 14, in the preferred embodiment extends between plate member 12 and elongate member 16 and is primarily responsible for maintaining each respective member in a fixed position with respect to the other. The length of intermediate member 14 is not crucial; however, intermediate member 14 should extend far enough from plate member 12 to ensure that elongate member 16 will clear any overhang roof structure. In the preferred embodiment, intermediate member 14 extends from the plane of plate member 12 in substantially perpendicular fashion. However, other useful embodiments are envisioned where intermediate member 14 extends from plate member 12 at various (and perhaps particular) angles to accommodate the need to adjust the relative position of the satellite. Also, as mentioned, in the preferred embodiment, plate member 12 and intermediate member 14 are forged with one another to form a single, modular piece. However, particularly useful embodiments are envisioned where each member is reversibly joined to the other where each may rotatably or slideably move with respect to the other. Finally, intermediate member 14 may be of adjustable length were its respective components may slide along, or telescope with respect to, one another to adjust the effective length of intermediate member 14. Such an embodiment is thought to be particularly useful where adjustments are needed to ensure the apparatus extends beyond the overhang of the roof.

As seen in the accompanying figures, intermediate member 14 is centrally offset with respect to plate member 12. This configuration is preferred in that it allows easy access to the centrally arranged apertures 18 or device 10. The amount and degree, if any, of the the offset of Intermediate member 14 is not crucial; however, the arrangement should be such that any cental apertures are accessed easily during installation. Of course, in the event there are no central apertures 18, no such offset would be necessary.

In the preferred embodiment, elongate member 16 is characterized by a first end and a second end. At its first end, elongate member 16 is configured to engage with intermediate member 14. At its second end, elongate member 16 is configured to engage with a satellite dish. Elongate member 16 extends from intermediate member 14 in substantially perpendicular fashion (and therefore substantially parallel to plate member 12). However, other useful embodiments are envisioned where elongate member 16 extends from intermediate member 14 at various (and perhaps particular) angles to accommodate the need to adjust the relative position of the satellite. Also, as mentioned, in the preferred embodiment, intermediate member 14 and elongate member 16 are forged with one another to form a single, modular piece. However, particularly useful embodiments are envisioned where each member is reversibly joined to the next where each may rotatably or slideably move with respect to the other. In these embodiments, each respective component would preferably be joined to the other by a bolt, pin, or screw, inserted though aligned apertures of each component to allow easy rotational adjustment. Finally, particularly useful embodiments are envisioned where elongate member is of adjustable length so the height of the satellite resting thereupon may be changed to ensure sufficient signal reception.

Perhaps the most novel aspect of the present invention lies with the configuration and function of elongate member 16. That is, by virtue of its engagement with any standard satellite dish, and the relative configuration of each member, device 10 eliminates the need to use the “j-pole” as is typically relied upon in satellite installation and support. Applicant's invention allows a satellite to rest upon, and have a full range of motion in relation to, a single support. As such, the satellite dish itself is fully adjustable with respect to the horizon and directional orientation without use of the standard “j-pole.”

Importantly, the satellite is fully adjustable without the need to alter the present device in any way. Clearly, Applicant's invention renders the virtually always relied upon “j-pole” obsolete. The cumulative savings with respect to installation time and components parts is staggering. As such, Applicant's invention is thought to change the way things to the extent of revolutionizing the satellite installation industry.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. A support apparatus, comprising
a plate member
configured for being juxtaposed with a building;
an intermediate member
extending between said plate member and an elongate member;
said elongate member
having a first end and a second end, where said elongate member first end is engaged with said intermediate member, and said elongate member second is configured for receiving or engaging with a satellite dish.

2. The apparatus of claim 1, wherein
said plate member is permanently affixed to said intermediate member and said intermediate member is permanently affixed to said elongate member so that the combination of said plate member, said intermediate member, and said elongate member form a single, modular component.

3. The apparatus of claim 1, wherein
said intermediate member is rotationally engaged with said plate member so that said intermediate member may extend from said plate member at various angles.

4. The apparatus of claim 1, wherein
said intermediate member and said elongate member are rotationally engaged with one another so that each may be extend from the other at various angles.

5. The apparatus of claim 1, wherein
said intermediate member is rotationally engaged with said plate member so that said intermediate member may extend from said plate member at various angles, and said intermediate member and said elongate member are rotationally engaged with one another so that each may be extend from the other at various angles.

6. The apparatus of claim 1, wherein
said intermediate member is of adjustable length and said elongate member is of adjustable length.

7. The apparatus of claim 1, wherein
said plate member is of generally rectilinear dimension and has at least two opposing slanted edges.

8. The apparatus of claim 1, wherein
said plate member is of a generally curvilinear dimension.

9. A support apparatus, comprising
a plate member
configured for being juxtaposed with a building, being of a generally planar, rectilinear dimension, having two opposing slanted sides where each slanted side meets the other at a medial point;
an intermediate member
extending from said plate member in substantially perpendicular fashion, and extending to an elongate member;
said elongate member
extending from said intermediate member in substantially perpendicular fashion, having a first end and a second end, where said elongate member first end is engaged with said intermediate member, and said elongate member second is configured for receiving or engaging with a satellite dish.
wherein
said plate member is permanently affixed to said intermediate member and said intermediate member is permanently affixed to said elongate member so that the combination of said plate member, said intermediate member, and said elongate member form a single, modular component.

10. A method for securing a satellite dish to a building, comprising the steps of:
selecting a support apparatus, comprising:
a plate member
configured for being juxtaposed with a building;
an intermediate member
extending between said plate member and an elongate member;
said elongate member
having a first end and a second end, where said elongate member first end is engaged with said intermediate member, and said elongate member second is configured for receiving or engaging with a satellite dish.
securing said support apparatus to said building;
securing said satellite dish to said support apparatus.

11. A method for securing a satellite dish to a building, comprising the steps of:
selecting a support apparatus, comprising:
a plate member
configured for being juxtaposed with a building, being of a generally planar, rectilinear dimension, having two opposing slanted sides where each slanted side meets the other at a medial point;
an intermediate member
extending from said plate member in substantially perpendicular fashion, and extending to an elongate member;
said elongate member
extending from said intermediate member in substantially perpendicular fashion, having a first end and a second end, where said elongate member first end is engaged with said intermediate member, and said elongate member second is configured for receiving or engaging with a satellite dish.
wherein
said plate member is permanently affixed to said intermediate member and said intermediate member is permanently affixed to said elongate member so that the combination of said plate member, said intermediate member, and said elongate member form a single, modular component;
securing said support apparatus to said building;
securing said satellite dish to said support apparatus.
